(19) United States
(12) Patent Application Publication
(10) Pub. No.: US 2018/0189350 A1
(43) Pub. Date: Jul. 5, 2018

(54) STREAMING DATA PROCESSING METHOD, STREAMING DATA PROCESSING DEVICE AND MEMORY MEDIUM

(71) Applicant: HITACHI, LTD., Tokyo (JP)

(72) Inventor: Tsuneyuki IMAKI, Tokyo (JP)

(73) Assignee: HITACHI, LTD., Tokyo (JP)

(21) Appl. No.: 15/126,007

(22) PCT Filed: Sep. 4, 2015
(86) PCT No.: PCT/JP2014/073355

§ 371 Date: Sep. 14, 2016

(51) Int. Cl. G06F 17/30

(52) U.S. Cl. CPC G06F 17/30463; G06F 17/30454; G06F 17/30516; G06F 17/3038

(57) ABSTRACT

The processor receives a query definition and converts the query definition to a query graph; generates query control information that determines an execution sequence of operators comprising the query graph; generates a calculation thread including buffers, and stored number information; and configures, a temporary storage area; wherein the processor executes a calculation thread; each time the processing for an operator is completed, the increase or decrease in tuples, which is inputted or outputted between the temporary storage area and the buffers, is stored in the stored number information for each tuple; after the processing of the last operator comprising the query graph in the calculation thread has been completed, the sum of the stored number information is computed for each tuple; tuples that have become unnecessary are identified on the basis of the sum and a threshold value; and the area of the identified tuples are recovered.

### BACKGROUND

The present invention relates to a technology for improving the performance of stream data processing.

Due to the increasing demands for real-time analysis of information generated continuously at a high rate, such as automation of security exchange, enhancement of traffic information processing, and analysis of click streak, to immediately take necessary actions for important events, the stream data processing that realizes real-time processing of high-rate data is attracting attention.

The stream data processing is a general middle-ware technology that can be used for various types of data processing, and it can reflect real-world data on business in real-time while adapting drastic changes in a business environment that cannot be addressed if a system is to be configured for each individual case.

The steam data processing uses stream as a processing target. The stream is chronological data string including a plurality of tuples that arrive successively, each of which includes a data value and a time stamp. When the user of the stream data processing defines the monitoring rules for this stream as a query, the query definition is converted to a query graph. The query graph is a directed graph in which a processing unit called an operator is used as a node, and a tuple queue between the operators is used as an edge. Each tuple comprising the input stream is allowed through the query graph, and is thereby processed as a data flow. Because this is a data flow-type process, by dividing the query graph into multiple stages and conducting processes in parallel in a pipeline manner using a plurality of computing resources, the through-put can be improved.

In modern computers, a multi-core processor that includes a plurality of CPU cores (or processor cores) is used, and a plurality of threads are processed at the same time. Patent Document 1 (WO2014/041673) is known as the technology to achieve high through-put by conducting the stream data processing using the multi-core processor.

In the Patent Document 1, a query parser that converts query definition into a query graph to determine the execution order of operators is provided together with a plurality of query execution threads, thereby performing the stream processing. In the execution order, a group of successive operators is referred to as a stage, and the total of the calculation cost of the operators that comprise each stage is referred to as the calculation cost of the stage. The query parser is configured to divide the query graph into a plurality of stages so that the calculation cost of each stage is smaller than the value obtained by dividing the total cost of all operators by the number of CPU cores. Each CPU core takes out one tuple at a time from the input stream, and in processing the assigned tuple from the entrance to the exit of the query graph, before performing the process of each stage, the CPU core is configured to determine whether the process of the stage has been completed for a tuple preceding the subject tuple or not.

### SUMMARY

In this conventional configuration, one tuple is used by a plurality of CPU cores, and a tuple is stored in tuple input/output buffers, which is assigned to each CPU core, as well as an operator execution state holding area, which is shared by all CPU cores. When the process of an operator is completed, each CPU core discards tuples that are no longer necessary in the operator, and tuples in the tuple input/output buffers. The tuples not used by any operators are deleted from the memory by the stream data processing part, and the stream data processing part recovers the area of the deleted tuples as an area to store new tuples.

In order to manage tuples, a counter that counts the number of movements of each tuple to and from the holding area of each operator can be used, for example, and a tuple is discarded when the counter value is zero. In this example, a counter is accessed by a plurality of CPU cores, and therefore, it is necessary to perform the exclusion control so that when the counter is accessed by one CPU core, access from other CPU cores is prohibited.

With this exclusion control, when a plurality of CPU cores attempt to access the counter, only one CPU core is allowed, and other CPU cores are put on hold. In the CPU cores put on hold, the process of the operator and the like is delayed, and as a result, the system through-put degrades.

A representative aspect of the present disclosure is as follows. A stream data processing method in which a received tuple is processed with a query using a computer that includes a processor and a memory, the method comprising: a first step in which the computer generates query execution control information by receiving query definition, converting the query definition into a query graph, and determining an execution order of operators included in the query graph; a second step in which the computer generates a calculation thread that includes an input buffer configured to store the tuple, an output buffer configured to store a resultant tuple as a process result of the operator, and saved number increase and decrease information configured to store an increase and decrease number of the tuple, and the computer assigns the calculation thread to the processor; a third step in which the computer configures a temporary storage area in the memory, the temporary storage area being able to store therein the tuple for each of the operators temporarily; a fourth step in which the computer executes the calculation thread using the query execution control information after receiving the tuple, and the calculation thread stores, in the saved number increase and decrease information, an increase or decrease number of the tuple that was input into and output from the temporary storage area and the input buffer or the output buffer for each tuple when a process of each of the operators is completed; a fifth step in which the computer calculates a sum of the saved number increase and decrease information for each tuple after the calculation thread completes the process of the last operator in the query graph, and conducts a reference number bulk updating process to identify a tuple that is no longer necessary based on the sum and a prescribed threshold; and a sixth step in which the computer recovers an area of the identified tuple.

According to the present invention, however, the information that manages tuples is not locked, and therefore, it is possible to improve the through-put of the stream data processing by a plurality of processors.

### BRIEF DESCRIPTION OF THE DRAWINGS

FIG. 1 is a block diagram showing an example of a computer system that conducts the stream data processing according to an embodiment of this invention.

FIG. 2A is a block diagram showing the query execution thread in detail according to the embodiment of this invention.

FIG. 2B is a block diagram showing the operator execution state holding area stored in the query execution state holding area according to the embodiment of this invention.

FIG. 2C is a block diagram showing an example of the tuple pool according to the embodiment of this invention.

FIG. 3A is a block diagram showing an example of starting the process of the next stage after the process of the previous stage according to the embodiment of this invention.

FIG. 3B is a block diagram showing an example of the reference counter bulk updating process according to the embodiment of this invention.

FIG. 4 is a block diagram showing an example of the stream data processing according to the embodiment of this invention.

FIG. 5A is a block diagram showing an example of the query graph according to the embodiment of this invention.

FIG. 5B is a diagram showing an example of the relationship between the stages divided from the query graph according to the embodiment of this invention.

FIG. 5C is the time chart that shows the relationship between the process of a stage conducted by each CPU core and the time according to the embodiment of this invention.

FIG. 6A is the first half of the flowchart showing an example of the query execution thread according to the embodiment of this invention.

FIG. 6B is the second half of the flowchart showing an example of the query execution thread according to the embodiment of this invention.

FIG. 7 is a flowchart showing an example of the reference counter bulk updating process according to the embodiment of this invention.

FIG. 8 is an example of the screen image output by the stream data processing part according to the embodiment of this invention.

FIG. 9 is a block diagram showing an example of conducting the stream data processing by the bulk updating process of the reference counter according to the embodiment of this invention.

FIG. 10 is a block diagram showing an example of conducting the stream data processing by the copy process according to the embodiment of this invention.

FIG. 11 is a graph showing the relationship between the through-put of the stream data processing and the number of CPU cores according to the embodiment of this invention.

FIG. 12 is the time chart that shows another example of the relationship between the processes of stages conducted by each core and the time according to the embodiment of this invention.

### DETAILED DESCRIPTION OF THE PREFERRED EMBODIMENTS

Below, an embodiment of the present invention will be explained with reference to the appended figures.

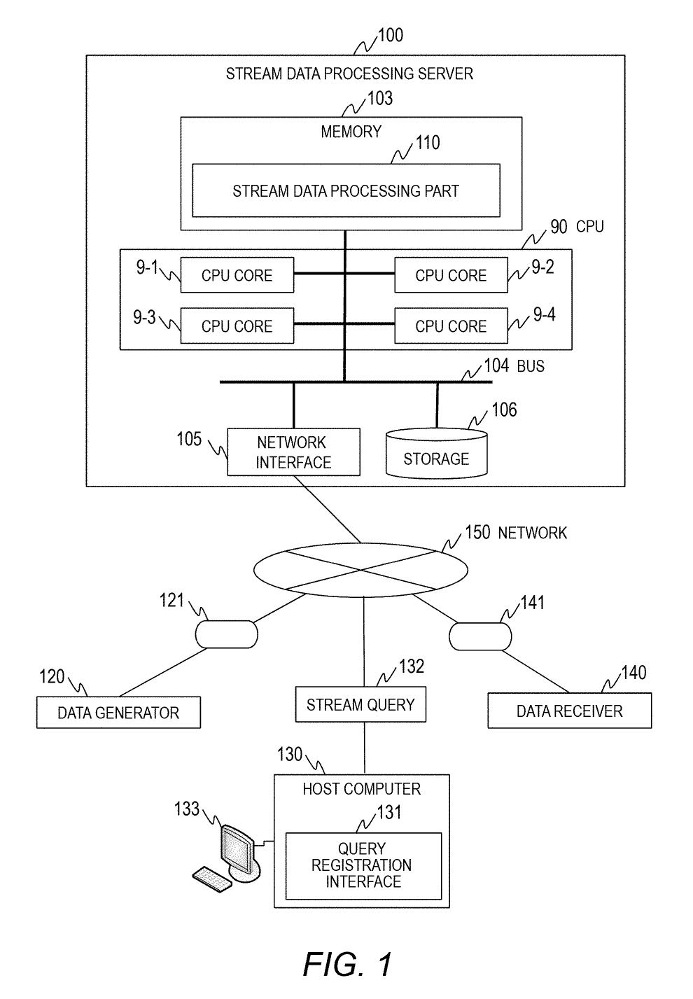

FIG. 1 is a block diagram showing an example of a computer system that conducts the stream data processing. The stream data processing server 100 is a computer that includes a CPU 90 comprised of CPU cores 9-1 to 9-4, a memory 103 that stores data and programs, a network interface 105 coupled to a network 150, a storage 106 that stores data and programs, and a bus 104 to which those computer resources are coupled.

The memory 103 includes a stream data processing part 110 that defines the stream data processing. The stream data processing part 110 is an executable image that can be executed by the CPU cores (computer cores) 9-1 to 9-4. The CPU cores 9-1 to 9-4 are collectively denoted by the reference character 9 with no hyphen. This also applies to other comprising elements. That is, individual element is denoted by −1 to −n, and a plurality of such elements are collectively denoted by the reference character with no hyphen.

The stream data processing server 100 is coupled to the network 150 via the network interface 105. A host computer 130 coupled to the network 150 transmits a stream query 132 defined by the user to the stream data processing server 100 via a query registration command executing interface 131. The host computer 130 receives inputs from users through an input/output device 133, and displays outputs from the stream data processing server 100 and the like in the input/output device 133. The stream data processing server 100 that received the stream query 132 from the host computer 130 causes the stream data processing part 110 to construct a query graph for conducting the stream data processing in accordance with the received query definition (stream query 132).

The stream data processing server 100 receives a tuple 121 sent from a data generator 120 coupled to the network 150. The tuple 121 is data with a time stamp. The stream data processing server 100 processes the received tuple in accordance with the query graph and generates a resultant tuple 141. The stream data processing server 100 sends this resultant tuple 141 to a data receiver 140 coupled to the network 150.

The storage 106 of the stream data processing server 100 stores text files of the stream query 132 that was received once, in addition to the executable image of the stream data processing part 110. The stream data processing part 110 may be configured to load the query files from the storage 106 upon start-up and construct a query graph.

The respective function parts such as the stream data processing part 110 are loaded to the memory 103 as programs. The CPU 90 conducts processes in accordance with a program of each function part, thereby operating as a function part that realizes a prescribed function. For example, by conducting processes in accordance with the stream data processing program, the CPU 90 functions as the stream data processing part 110. The same applies to other programs. The CPU 90 also operates as a function part that realizes each function of a plurality of processes conducted by respective programs. The computer and computing system are a device and system that include those function parts.

Information for realizing the respective functions of the stream data processing part 110 such as programs and tables can be stored in the storage 106, a memory device such as a non-volatile semiconductor memory, hard disk drive, or SSD (solid state drive), or a computer readable non-temporary data storage medium such an IC card, SD card, or DVD.

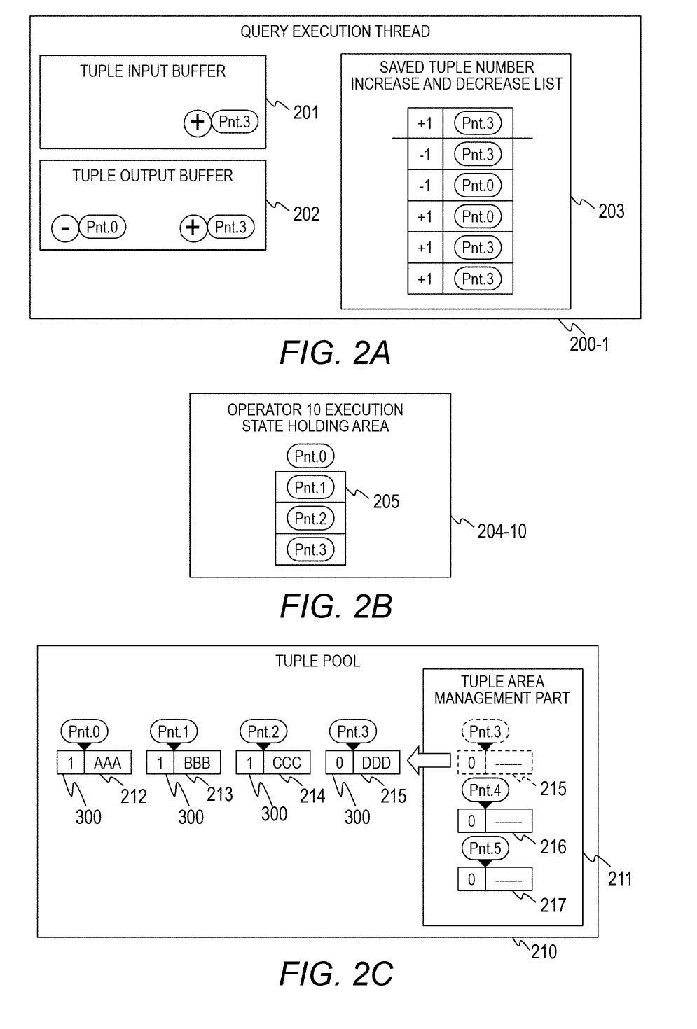

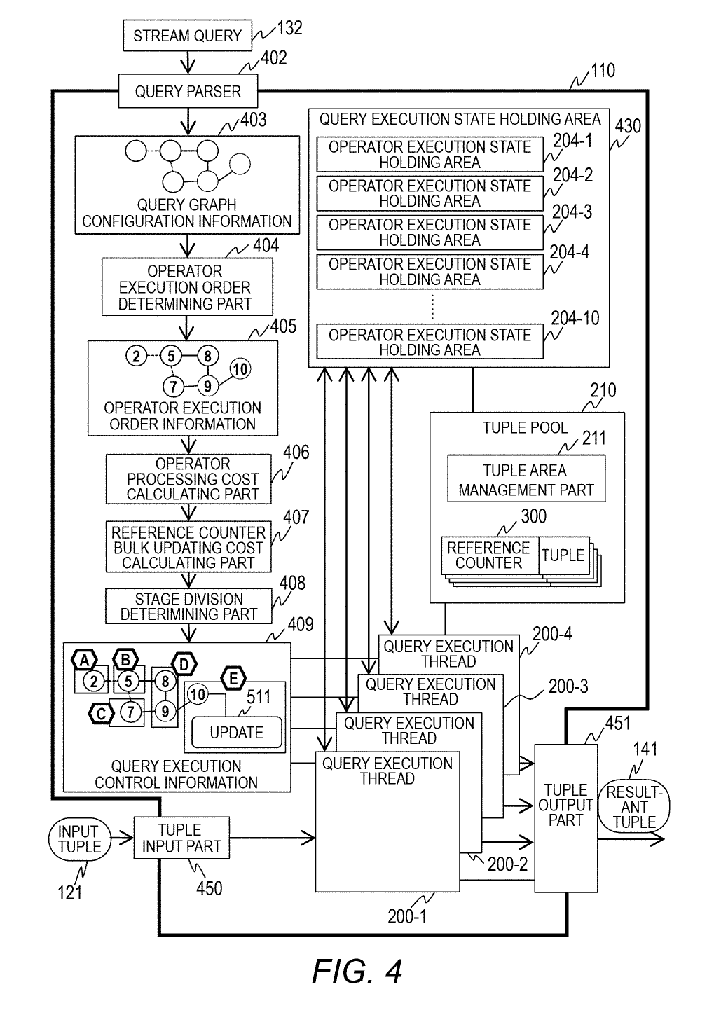

The logic configuration of the stream data processing part 110 will be explained with reference to FIG. 4 and FIGS. 2A to 2C.

FIG. 4 is a block diagram showing an example of the stream data processing.

When the host computer 130 conducts a registration operation of a stream query 132, a query parser 402 converts the stream query 132 to query graph configuration information 403. An operator execution order determining part 404 processes the query graph configuration information 403, determines the execution order of the operators comprising the query graph, and outputs the order as operator execution order information 405. A known technology can be used for the process to determine the execution order of the operators, and the technology disclosed in Japanese Patent Application Laid-open Publication No. 2010-108152 can be employed, for example.

An operator processing cost calculating part 406 calculates an estimate result of the processing time of each operator in the query graph as the calculation cost. A reference counter bulk updating cost calculating part 407 calculates, as the calculation cost, an estimate result of the processing time of the bulk updating process of a reference counter 300, which is added to the end of the query graph. The reference counter bulk updating cost calculating part 407 can obtain an estimate of the processing time in a manner similar to the operator processing cost calculating part 406 described in Patent Document 1.

The calculation cost of the operator processing cost calculating part 406 and the calculation cost of the reference counter bulk updating cost calculating part 407 are input into a stage division determining part 408. The stage division determining part 408 divides the query graph and a reference counter bulk updating process 511 into a plurality of stages. The operator processing cost calculating part 406 and the stage division determining part 408 are similar to those of Patent Document 1.

In this specification, the stage refers to one or more successive operators in the execution order of the operators that comprise the query graph. In this embodiment, the stage is treated as one processing unit, and each CPU core 9 conducts a process of each stage at a time.

The stream data processing server 100 adds the stage division result to the query graph, and generates query execution control information 409 in the end. The query execution control information 409 generates as many query execution threads 200 as the number of the CPU cores 9, and assigns those threads to the respective CPU cores 9.

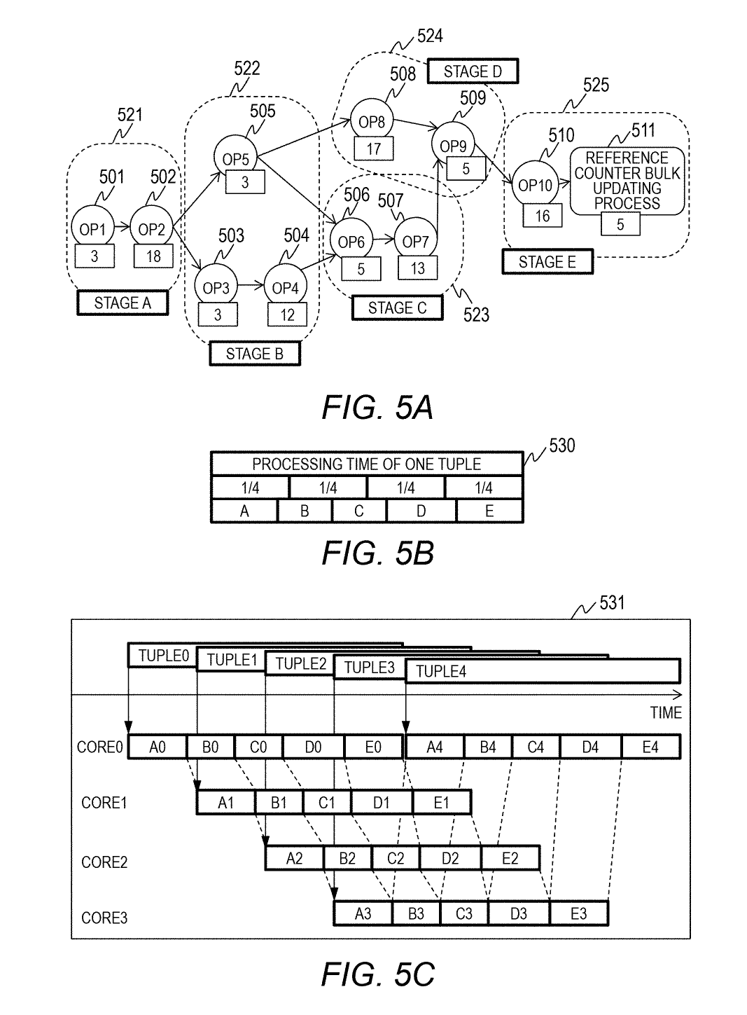

In this embodiment, the respective stages A, B, C, D, and E are made up of operators (OP) 1 to (OP) 10 as shown in FIG. 5A. The stage dividing method is similar to that of Patent Document 1, and therefore, the method is not described in detail here. In the example shown in the figure, stage A (521) includes operators 1 (501) and 2 (502), stage B (522) includes operators 3 (503), 4 (504), and 5 (505), stage C (523) includes operators 6 (506) and 7 (507), stage D (524) includes operators 8 (508) and 9 (509), and stage E (525) includes an operator 10 (510) and the reference counter bulk updating process (511). As described above, the stream data processing server 100 performs processes up to the generation of the query execution control information 409 during the query registration.

Next, processes during the query execution will be explained. When the stream data processing server 100 executes a query, the query execution threads 200-1 to 200-4 start processes in accordance with the number of computing resources (number of cores of CPU 90) in the computer environment. This embodiment shows an example of executing four query execution threads 200-1 to 200-4 in an environment where four CPU cores 9-1 to 9-4 can be used.

In the steam data processing of this embodiment, one query execution thread 200 that executes data processing is bound with each of the tuples that arrive successively to the stream data processing server 100, and the respective tuples are processed in parallel. That is, each of the plurality of CPU cores 9 executes one of the divided stages A to E, and the process for one tuple 121 is completed by one CPU core 9.

Thus, when a tuple input part 450 shown in FIG. 4 receives input tuples 121, the tuple input part 450 gives a serial number, which is one of a series of whole numbers that increment by one, to each of the tuples 121, and transfers the tuples 121 to the query execution threads 200-1 to 200-4, respectively. Among the query execution threads, one of the suspended query execution threads 200-n processes the tuple 121.

For example, a case in which the serial number “88” is given to a tuple 121 and the query execution thread 200-1 is assigned to process the tuple 121 will be explained. The query execution thread 200-1 stores this serial number “88” in the operator execution state holding area 204-1. The operator execution state holding area 204-1 is an area where the execution state of the operator 1 is held. Also, in this case, a tuple that immediately precedes the tuple 121, or in other words, the tuple with the serial number “87” is to be processed by the query execution thread 200-4.

The query execution thread 200-1 starts the process of the tuple with the serial number “88” from the process of stage A. Before that, the query execution thread 200-1 determines whether or not the query execution thread 200-4 has completed the process of stage A for the tuple that immediately precedes the tuple with the serial number “88”, or in other words, the tuple with the serial number “87” that is assigned to the query execution thread 200-4.

In this embodiment, each of the query execution threads 200-1 to 200-4 is configured to change the value of the serial number flag of completed tuple (not shown in the figure) for the corresponding stage, which is configured in a query execution state holding area 430, from the serial number of the assigned tuple (tuple that underwent the process of the stage) to the next serial number when the process of the assigned tuple 121 is completed in each stage. This process can be performed using the technology of Patent Document 1.

When the serial number does not match the serial number of the assigned tuple, which is “88,” or in other words, when the process of stage A of the tuple with the immediately preceding serial number “87” has not been completed, the query execution thread 200-1 waits to start the process.

The query execution thread 200-4 adds 1 to the serial number value when the process of stage A (or the process of the operator 2) is completed for the tuple with the serial number of “87.” The query execution thread 200-1 repeatedly conducts this determining process at a certain interval before starting the process of stage A, for example, and after confirming that the change has been made to the flag value, the query execution thread 200-1 starts the process of stage A for the serial number “88.”

As described above, each of the query execution threads 200-1 to 200-4 is configured to determine whether or not another query execution thread has completed the process of a stage for the immediately preceding tuple before starting the process of that stage. A known technology can be employed for the method to determine whether the process has been completed by the respective query execution threads 200.

The execution state of the operators (OP1 to OP10) of each stage A to E is managed in the operator execution state holding areas 204-1 to 204-10 in the query execution state holding area 430, and is shared by all of the query execution threads 200-1 to 200-4. The operator execution state holding areas 204-1 to 204-10 function as temporary storage areas of tuples used by the respective operators.

The tuple input part 450 compares the time stamp of the registered tuple and the time stamp of the first tuple that is given to the input stream, and gives serial numbers to the respective tuples from older to newer. Thereafter, the tuple input part 450 transfers the tuples to the query execution threads 200-1 to 200-4.

In the query execution thread 200, the processes of stages A to E are conducted successively for the respective input and output tuples. Those processes are conducted in parallel. The query execution thread 200 controls the process of each operator such that the process of a tuple 121 is not conducted before the process of the preceding tuple 121 is completed.

The query execution thread 200 obtains areas 212 to 215 in the memory 103 that has stored therein the tuple data and the reference counter 300 from a tuple area management part 211 that manages a tuple pool 210 before processing the tuples. Each operator performs calculation using pointers (Pnt.0 to Pnt.3) of the areas 212 to 215 in the memory 103.

The operators having Window, Join, Group By, or the like as the execution state each include an operator execution state holding area 204-1 to 204-10 that stores tuples (or tuple pointers) as shown in FIG. 2B. For example, the operator 1 (OP1) of stage A has the operator execution state holding area 204-1 for temporarily storing tuples, and can thereby save an input tuple or generated tuple.

The tuple stored in the operator execution state holding area 204-1 is discarded when it is no longer necessary. In this embodiment, in order to determine whether the tuple in the operator execution state holding area 204-1 is necessary or not, the reference counter bulk updating process is conducted in stage E, which is the final stage. After the process, if the value of the reference counter 300 for the tuple is a prescribed value, the tuple is discarded, and the tuple area management part 211 recovers the area assigned to the tuple.

The tuple output from the query execution thread 200 is output from a tuple output part 451 as a resultant tuple 141. The stream data processing server 100 sends the resultant tuple 141 to the data receiver 140 via the network 150.

In this embodiment, the query execution thread 200 that conducts a series of processes for tuples is configured to perform the reference counter bulk updating process in the final stage E, and therefore, it is possible to limit the number of CPU core 9 that operates the reference counter 300 to one. As a result, the need for the exclusion control (lock) of the reference counter 300 is eliminated, and the overhead due to the exclusion control can be reduced.

FIG. 2A is a block diagram showing the query execution thread 200-1 in detail. The query execution threads 200-2 to 200-4 have the same configuration. The query execution thread 200-1 includes a tuple input buffer 201 that stores an input tuple or a pointer of an input tuple, a tuple output buffer 202 that stores an output tuple or a generated tuple, and a saved tuple number increase and decrease list 203 that saves an increase and decrease of tuples that are input to and output from the query execution thread 200-1, which are used for the processes of stages A to E described above.

That is, after the query execution thread 200-1 completes the process of stage A, the process of stage B is conducted using the same values. The tuple output buffer 202 used in the process of stage A functions as the tuple input buffer 201 of stage B, maintaining the same values. The pointer of the tuple stored in the tuple input buffer 201 is discarded when the process of the operator is completed.

In the figure, the tuple input buffer 201 and the tuple output buffer 202 include pointers (Pnt.0, Pnt.3) for the areas where the tuples are stored and symbols “+” and “−” that indicate the state of the respective pointers. The symbol “+” indicates that the active period of the tuple represented by the pointer has started, and the symbol “−” indicates that the active period of the tuple represented by the pointer has ended.

The saved tuple number increase and decrease list 203 manages an increase and decrease value of the saved tuple number for each tuple in the operator execution state holding area and the input and output buffers of each CPU core, in accordance with the input and output of tuples by the operators in each stage. The first row of 203 indicates that the tuple represented by the pointer in the figure (Pnt.3) was generated and stored in the tuple input buffer 201 in the process of the operator 9. The rows below the first row show an example in which the process was conducted by an operator in the order of discarding (clearing the tuple input buffer after the process of the operator 10), storing (storing in the operator execution state holding area 204-10), and storing (storing in the tuple output buffer 202). Similarly, the figure shows an example in which the tuple represented by the pointer (Pnt.0) is subjected to the process by an operator in the order of discarding (deleting from the operator execution state holding area 204-10) and storing (storing in the tuple output buffer 202).

FIG. 2B shows the operator execution state holding area 204-10 stored in the query execution state holding area 430. As shown in FIG. 4, the operator execution state holding areas 204-1 to 204-9 of the operators 1 to 9 have the same configuration. The reference character 205 in the figure indicates an area where the tuples held in the operator execution state holding area 204-10 are stored, and the tuple (Pnt.0) outside of 205 in the figure indicates the tuple that is deleted from the operator execution state holding area 204-10.

FIG. 2C is a block diagram showing an example of the tuple pool 210. The tuple pool 210 has the tuple area management part 211 that assigns an area of the memory 103 to each tuple, and the reference counters 300 that each determine whether the tuple to which an area was assigned is necessary or not.

The tuple area 212 of the figure indicates that the reference pointer thereof is Pnt.0 and that the value of the reference counter 300 is “1.” The tuple area 215 indicates that this area is assigned to the tuple with the value “DDD,” the reference pointer thereof is Pnt.3, and the value of the reference counter 300 is “0.” The tuple area management part 211 secures the areas 216 and 217 as unassigned areas.

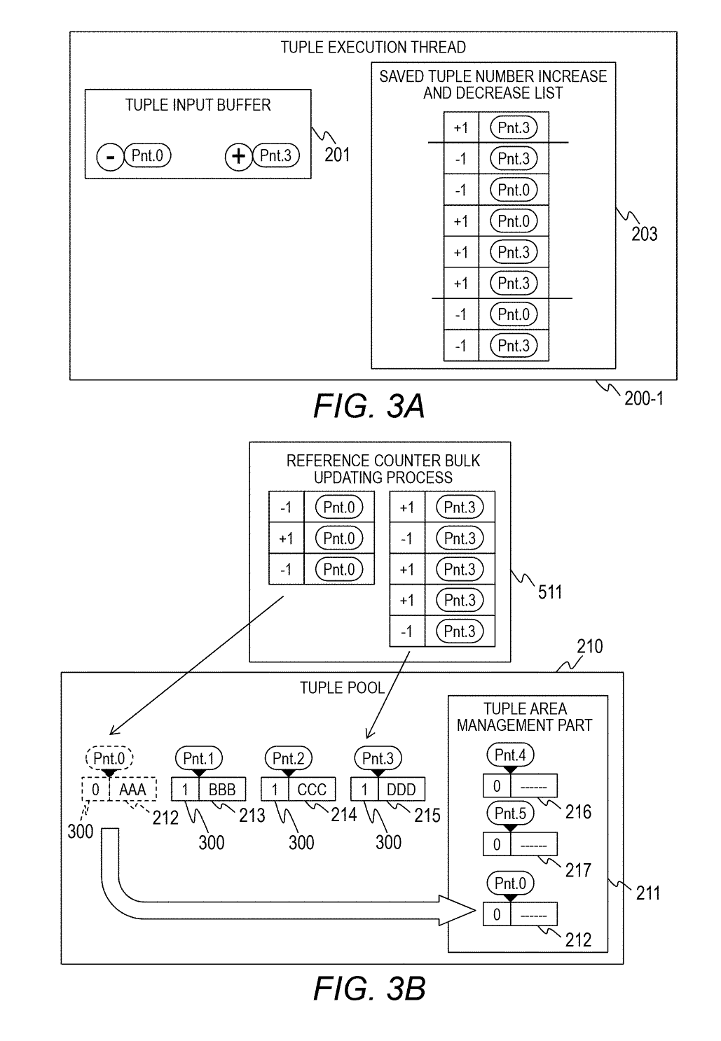

FIGS. 3A and 3B show an example in which the reference counter bulk updating process (511) is conducted before moving to the next stage of FIGS. 2A and 2C, so that the tuple of the pointer Pnt.0 is discarded and the tuple area 212 is recovered by the tuple area management part 211. FIG. 3A shows an example of starting the process of the next stage after the process of the previous stage is conducted in FIG. 2A, for example.

In this example, in the query execution thread 200-1, the tuple input buffer 201 is the tuple output buffer 202 shown in FIG. 2A, and the tuple output from the process of the previous stage is used for the input tuple of the next stage.

FIG. 3B shows an example in which the process of stage E is completed in FIG. 2A and the reference counter bulk updating process (511) is conducted after the operator 10 (see FIG. 5A). The query execution thread 200-1 conducts the reference counter bulk updating process (511) and calculates the sum of tuples by each tuple pointer in the saved tuple number increase and decrease list 203.

In the tuple pool 210, the value of the reference counter 300 for Pnt.0 is “0,” and the value of the reference counter 300 for the pointer Pnt.3 is “1.”

In the reference counter bulk updating process 511, the query execution thread 200 that conducts this process tallies up the saved tuple number increase and decrease list 203 by pointer or tuple, and if the resultant value is “0,” the query execution thread 200 determines that the tuple is no longer necessary. The query execution thread 200 then causes the tuple area management part 211 to recover the area 212, for which the value of the reference counter 300 is “0,” as an unassigned area.

With the process described above, when an area in the memory 103 that has been assigned to a tuple by the tuple area management part 211 is deemed unnecessary by the query execution thread 200 at the end of each stage, the area is recovered by the tuple area management part 211, and restored as an area for receiving a new tuple.

### <Stage Division Determining Part>

Next, with reference to FIGS. 5A to 5C, the stage division method in the stage division determining part 408 will be explained. In the present embodiment, an example in which the stream query 132 received by the query parser 402 of FIG. 4 is converted to the query graph configuration information 403 including the operator (OP)1 to operator (OP)10 of FIG. 5A, and the reference counter bulk updating process is added thereto will be explained.

The operator execution order for the query graph comprised of the operator (OP)1 to operator (OP)10 and the reference counter bulk updating process, which is determined by the operator execution order determining part 404, is starting from the operator 1 through 10, and then the reference counter bulk updating process 511. In this embodiment, queries are executed by four CPU cores 9. The total calculation cost of the operators 1 to 10, which was calculated by the operator processing cost calculating part 406, is 95, and because the calculation cost of the reference counter bulk updating process, which was calculated by the reference counter bulk updating cost calculating part 407, is 5, the sum of the calculation cost is 100.

The stage division determining part 408 configures the threshold value of the calculation cost to 22 by dividing the total calculation cost of the query graph (100, for example) by the number of calculation cores (CPU cores 9) (four, for example), which results in 25, and subtracting a prescribed margin from the resultant value of 25.

The stage division determining part 408 sums up the respective calculation costs of the operators successively in accordance with the execution order of the operators, and divides the graph into multiple stages so as not to exceed the threshold (22).

In this embodiment, because the sum of the calculation costs of the operators 1 and 2 is 21, and the sum of the calculation costs of the operators 1 to 3 is 24, the range of the first stage A is up to the operator 1 so that the sum does not exceed a threshold value of 22. Thereafter, by applying this division policy, OP 3 to 5, OP 6 to 7, OP 8 to 9, and OP 10 and the reference counter bulk updating process are respectively configure as stages B to E, and the graph is divided into the total of five stages (521 to 525).

The calculation costs of the respective stages are as follows: stage A (521) is 21, stage B (522) is 18, stage C (523) is 18, stage D (524) is 22, and stage E (525) is 21. The ratio of the processing time of each stage to the processing time of one tuple is as shown in 530 of FIG. 5B. FIG. 5B is a diagram showing an example of the relationship between the stages divided from the query graph and the calculation costs.

In the case where input tuples 121 arrive at a time interval of one-fourth the tuple processing time, if the process is conducted in accordance with the configuration shown in FIG. 4, each tuple is processed based on the schedule shown in the time chart 531 of FIG. 5C in each calculation core. FIG. 5C is the time chart 531 that shows the relationship between the process of a stage conducted by each CPU core 9 and the time. In the figure, core 0 corresponds to the CPU core 9-1 of FIG. 1, and cores 1 to 3 respectively correspond to CPU cores 9-2 to 9-4.

In the process of this embodiment, if input tuples 121 keep coming in at a constant interval, there is no blank time (wait time before starting a process) as shown in the time chart 531 of FIG. 5C. If the time interval at which the input tuples 121 come in fluctuates, the waiting time could occur.

In the description above, the threshold value of the calculation cost is configured to 22 based on a value of 25, which is obtained by dividing the total calculation cost by the number of cores, i.e., 4, and the range of each stage was determined by consolidating operators successively so as not to exceed this threshold value. Whether the blank time occurs or not when the time interval at which the input tuples 121 arrive fluctuates depends on the size of the threshold value of the calculation cost.

By increasing the margin for the value obtained by the dividing the total calculation cost by the number of cores, or in other words, by making the threshold value of the calculation cost smaller so that the range of each stage assigned to each calculation core is narrowed down and the calculation time of one stage is sufficiently small, it is possible to avoid the occurrence of blank time caused by the fluctuation of the tuple arrival time interval.

If the shortest arrival time interval in the fluctuating arrival time of the input tuples 121 is known, the occurrence of the blank time can be completely avoided by making the processing time of each stage, which is conducted by each calculation core, shorter than the shortest arrival time interval. Thus, with this embodiment, it is possible to reduce latency and improve through-put, not only under the limited condition that the input tuples 121 arrive at a constant interval in a successive manner, but also when the arrival time interval fluctuates.

As shown in FIG. 5C, when the tuples 0 to 4 are input, tuple 0 is assigned to core 0, and the query execution thread 200-1 starts the process. Because there is no query execution thread 200 that precedes the query execution thread 200-1, the query execution thread 200-1 executes the respective stages A through E in this order.

On the other hand, core 1, to which tuple 1 is assigned, waits until core 0 completes the process of stage A0 before starting the process of stage A1. Similarly, other cores 2 to 3 wait until the preceding query execution thread 200 completes the process of stage A before starting the process of stage A by the corresponding query execution thread 200.

Therefore, in the present invention, no more than one core conducts the process of the same stage at any point in time, and the respective cores 0 to 3 successively conduct the processes of different stages in parallel. Thus, stages E0 to E4 for updating the reference counter 300 are conducted in that order at different timings, respectively. This eliminates the need to lock the reference counter 300 that manages tuples, and as a result, it is possible to improve the through-put of the stream data processing conducted by a plurality of CPU cores 9.

Predetermined values may be used for the calculation costs of the operators 1 to 10 and the reference counter bulk updating cost.

### <Query Execution>

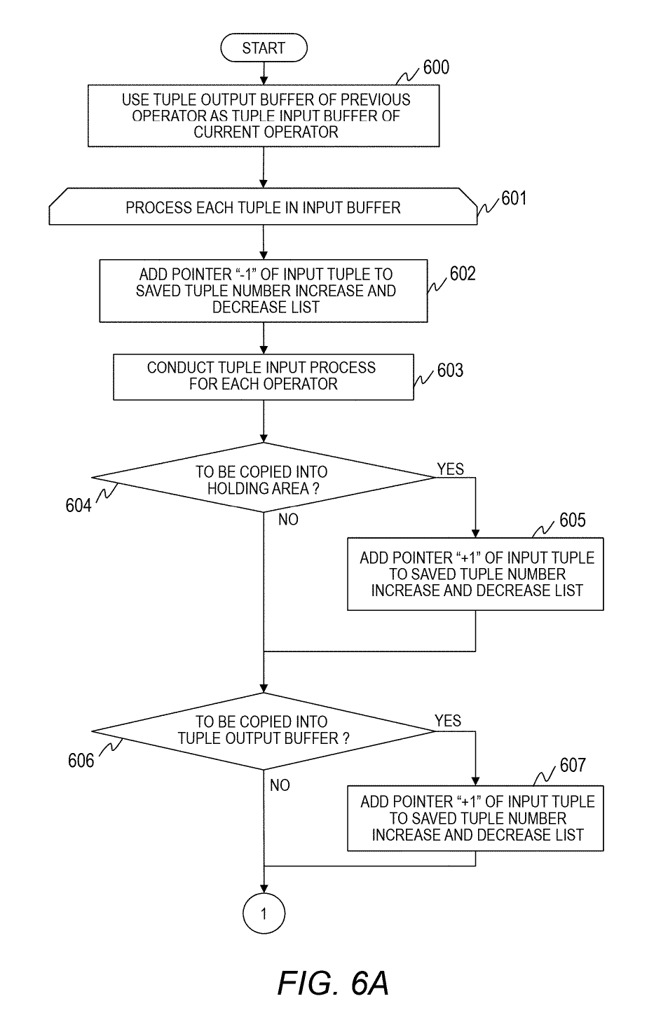

FIGS. 6A and 6B are flowcharts showing an example of the query execution process conducted by each CPU core 9. After receiving an input tuple 121, the stream data processing server 100 transfers the received input tuple 121 to the query execution thread 200 of each CPU core 9, and the query execution process is started.

First, if there is a preceding process, the query execution thread 200 uses the tuple output buffer 202 used by the previous operator as the tuple input buffer 201 for the next operator (600). In the very first process, the switching between the tuple output buffer 202 and the tuple input buffer 201 does not take place.

The query execution thread 200 conducts the processes of Steps S601 to 704 repeatedly for each tuple in the tuple input buffer 201. First, the query execution thread 200 adds the pointer of the input tuple 121 to be processed to the saved tuple number increase and decrease list 203, and configures the increase and decrease value of the saved number of the tuple to “−1” (602).

Next, the query execution thread 200 conducts the tuple input process of the subject operator (such as Window, Join, or Group By) (603). The query execution thread 200 determines whether or not the input process requires the input tuple to be copied (or saved) into the operator execution state holding area (holding area in the FIG. 204 of the operator (604). That is, if the operator is Window or the like, the input tuple needs to be copied into the operator execution state holding area 204, and therefore, the process moves to Step 605. If not, the process moves to Step 606.

In Step 605, the query execution thread 200 configures the increase and decrease value of the saved number of the input tuple to “+1,” and adds the entry to the saved tuple number increase and decrease list 203.

In Step 606, the query execution thread 200 determines whether or not the input process requires the input tuple to be copied (or saved) into the tuple output buffer 202. If the operator is Filter or the like, the input tuple needs to be copied (or saved) into the tuple output buffer 202, and therefore, the process moves to Step 607. If not, the process moves to Step 608.

In Step 607, because the query execution thread 200 copies the input tuple into the tuple output buffer 202, “+1” is added to the value of the saved tuple number increase and decrease list 203 of the input tuple.

In Step 608 of FIG. 6B, the query execution thread 200 conducts the resultant tuple generating process of the current operator. After the query execution thread 200 generated a resultant tuple, the query execution thread 200 obtains areas 122 to 125 for storing the resultant tuple and the reference counter 300 from the tuple area management part 211.

Next, in Step 609, the query execution thread 200 determines whether or not the resultant tuple generating process requires the resultant tuple to be copied (or saved) into the operator execution state holding area (holding area in the FIG. 204 of the operator. That is, if the operator is Join or the like, the resultant tuple needs to be copied (or saved) into the operator execution state holding area 204, and therefore, the process moves to Step 610. If not, the process moves to Step 611. In Step 610, the query execution thread 200 configures the increase and decrease value of the saved number of the resultant tuple to “+1,” and adds the entry to the saved tuple number increase and decrease list 203.

In Step 611, the query execution thread 200 conducts the resultant tuple output process of the current operator.

In Step 612, the query execution thread 200 determines whether or not the output process requires the resultant tuple to be copied (or saved) into the tuple output buffer 202. If the operator is Group By or the like, the resultant tuple needs to be copied (or saved) into the tuple output buffer 202, and therefore, the process moves to Step 613. If not, the process moves to Step 614.

In Step 613, because the query execution thread 200 copies (or saves) the resultant tuple into the tuple output buffer 202, the increase and decrease value of the saved number of the resultant tuple is configured to “+1,” and added to the saved tuple number increase and decrease list 203.

Next, in Step 614, the query execution thread 200 determines whether or not the output process requires the resultant tuple to be deleted from the operator execution state holding area 204. If the operator is Window, Group By, or the like, the resultant tuple needs to be deleted from the operator execution state holding area 204, and therefore, the process moves to Step 615. If not, the process moves to Step 616.

In Step 615, because the query execution thread 200 deletes the resultant tuple, the increase and decrease value of the saved number of the resultant tuple is configured to “−1,” and is added to the saved tuple number increase and decrease list 203.

With those processes mentioned above, the values of the saved tuple number increase and decrease list 203 are updated for each tuple in the respective operators 1 to 10.

### <Reference Counter Bulk Updating Process>

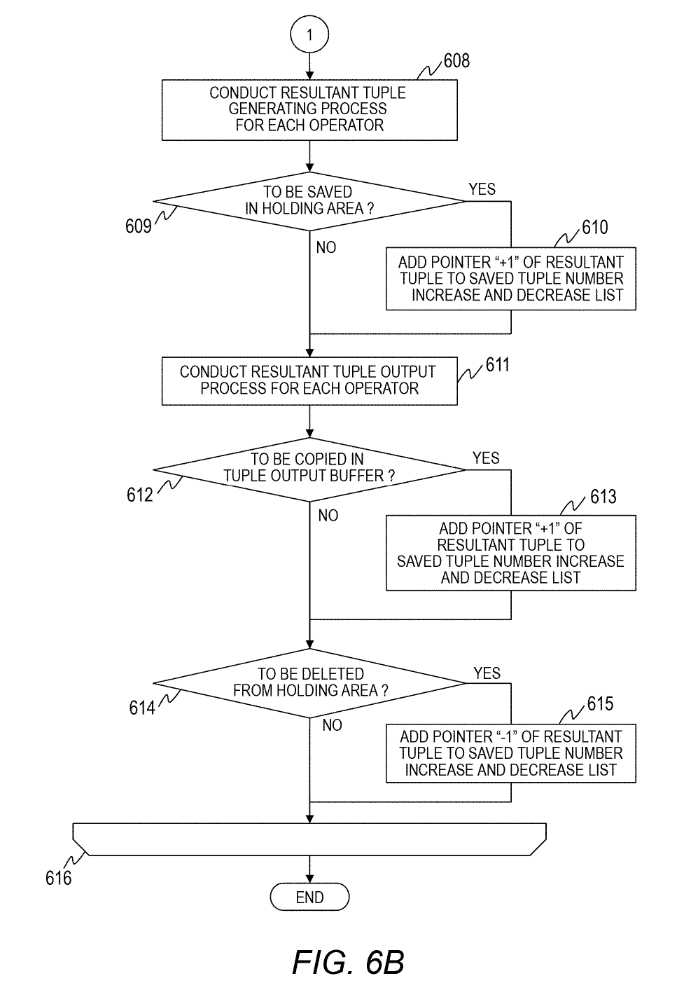

FIG. 7 is a flowchart showing an example of the reference counter bulk updating process conducted by each CPU core 9. As shown in FIG. 5A, the reference counter bulk updating process (511) is started by the query execution thread 200 after the process of stage E of the operator 10 (510) is completed. In FIG. 5C, the reference counter bulk updating process is conducted at different timings, respectively, in stages E0 to E4 of cores 0 to 3.

The query execution thread 200 conducts the processes of Steps 700 to 704 repeatedly for each tuple stored in the saved tuple number increase and decrease list 203. In Step 701, the query execution thread 200 obtains the increase and decrease number of each tuple from the saved tuple number increase and decrease list 203, and calculates the sum of the increase and decrease numbers for each tuple. The query execution thread 200 adds the calculated sum to the reference counter 300 of the corresponding tuple in the tuple pool 210 (710).

Next, the query execution thread 200 determines whether the value of the reference counter 300, to which the sum was added, is “0” or not (S702). If the value of the reference counter 300 is “0,” the process moves to Step 703, and the area assigned to the tuple is returned to the tuple area management part 211. By conducting this process for all of the tuples stored in the saved tuple number increase and decrease list 203 in the query execution thread 200, areas of tuples that are no longer necessary can be recovered by the tuple area management part 211.

Also, in this embodiment, it is not necessary to limit the access to the tuple reference counter 300, and therefore, the plurality of CPU cores 9 do not have to be put on hold, which makes it possible to improve the through-put of the stream data processing.

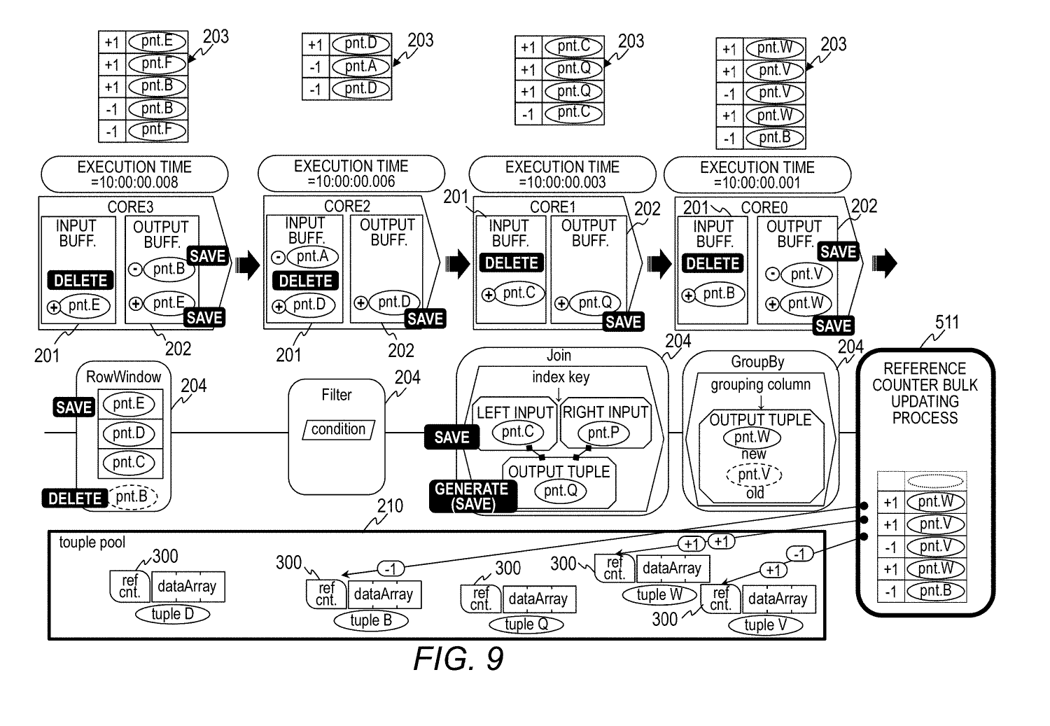

FIG. 9 is a block diagram showing an example of conducting the stream data processing by the bulk updating process of the reference counter. FIG. 9 shows an example in which the query execution thread 200 is executed by the respective cores 0 to 3 to process different operators, respectively. The saved tuple number increase and decrease list 203 is associated with the query execution thread 200 executed by each core.

Core 0 in the figure shows an example in which the operator of Group By is executed, and the resultant tuple in the operator execution state holding area 204 is saved in the tuple output buffer 202. Core 1 in the figure shows an example in which the operator of Join is executed, the input tuple 121 in the tuple input buffer 201 is saved in the operator execution state holding area 204, and the resultant tuple in the operator execution state holding area 204 is saved in the tuple output buffer 202.

Core 2 in the figure shows an example in which the operator of Filter is executed, and the input tuple in the tuple input buffer 201 is saved in the tuple output buffer 202. Core 3 in the figure shows an example in which the operator of Row Window is executed, the input tuple 121 in the tuple input buffer 201 is saved in the operator execution state holding area 204, and the resultant tuple in the operator execution state holding area 204 is saved in the tuple output buffer 202.

When each query execution thread 200 completes the corresponding operator process, a pointer of each tuple for which the saved number has increased or decreased due to the operator process is added to the saved tuple number increase and decrease list 203 of each query execution thread 200.

The saved tuple number increase and decrease list 203 stores, in association with the pointers of tuples, an increase and decrease value of those tuples that are input to and output from the operator execution state holding area 204 that functions as a temporary storage area of tuples, and the tuple input buffer 201 or tuple output buffer 202 of the query execution thread 200.

After the process of the last operator (or the last stage) of the query graph is completed, the query execution thread 200 conducts the reference counter bulk updating process 511.

The query execution thread 200 conducts the reference counter bulk updating process 511, thereby identifying tuples that are no longer necessary based on the sum of the saved tuple number increase and decrease list 203 and a prescribed threshold (0, for example), and causing the tuple area management part 211 to recover the areas of the tuples that are deemed unnecessary. The recovered areas are returned to the tuple pool 210 and used to store new tuples.

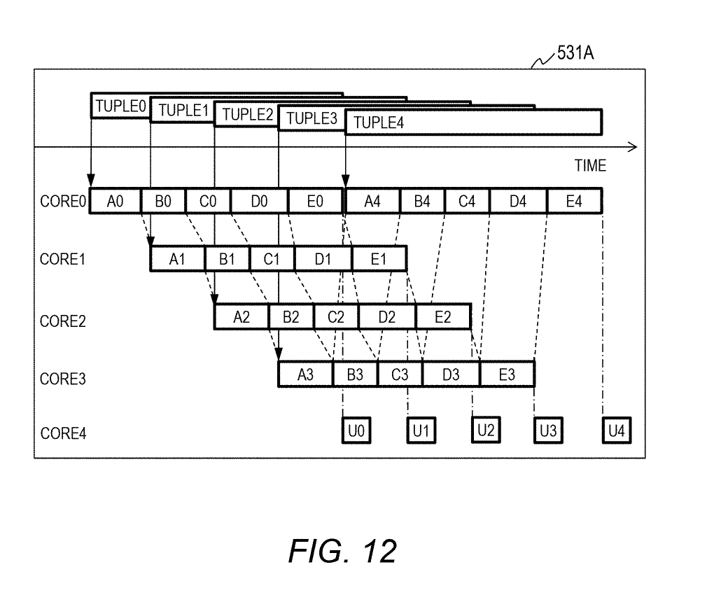

This embodiment shows the example in which the updating process of the reference counter 300 is conducted (bulk updating thread) after the process of the operator 10 is completed in the final stage E of the query execution thread 200 executed by each CPU core 9, but the present invention is not limited to this. For example, as shown in FIG. 12, the present invention may be configured such that core 4 is assigned to conduct the bulk updating process of the reference counter 300. FIG. 12 is the time chart 531A that shows another example of the relationship between the processes of stages conducted by each core and the time.

In this example, instead of the reference counter bulk updating process (511) of stage E, bulk updating threads U0 to U4 configured to conduct the bulk updating process of the reference counter 300 are assigned to core 4, which is independent of other cores. A query execution thread 200 is not assigned to core 4.

When the process of the operator 10 is completed in stages E0 to E4, each query execution thread 200 calls upon and activates the bulk updating threads U0 to U4 via core 4 to conduct the bulk updating process of the reference counter 300. If there is a CPU core 9 to which no query execution thread 200 is assigned, the bulk updating threads may be used in the manner shown in FIG. 12. Alternatively, the bulk updating threads may be executed by a plurality of CPU cores 9, or as described below, the stream data processing server 100 may assign as many bulk updating threads as the received division number to the CPU cores 9.

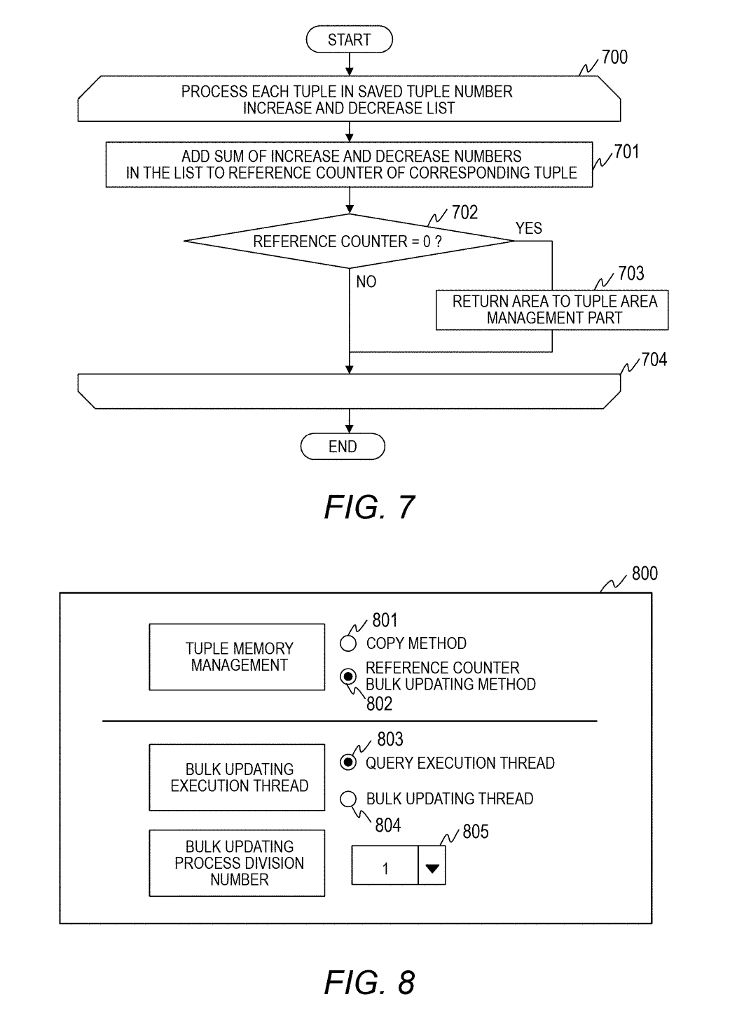

FIG. 8 is an example of the screen image output by the stream data processing part 110. A screen 800 is displayed in the input/output device 133 of the host computer 130, for example, as a user interface that receives the configuring of the query execution.

The tuple memory management in the screen 800 allows the user to select either the reference counter bulk updating process described above or the copy process (will be described below). When a check box 802 is selected, the tuple pool 210 and the tuple area management part 211 manage areas of the memory 103 to store tuples using the reference counter 300.

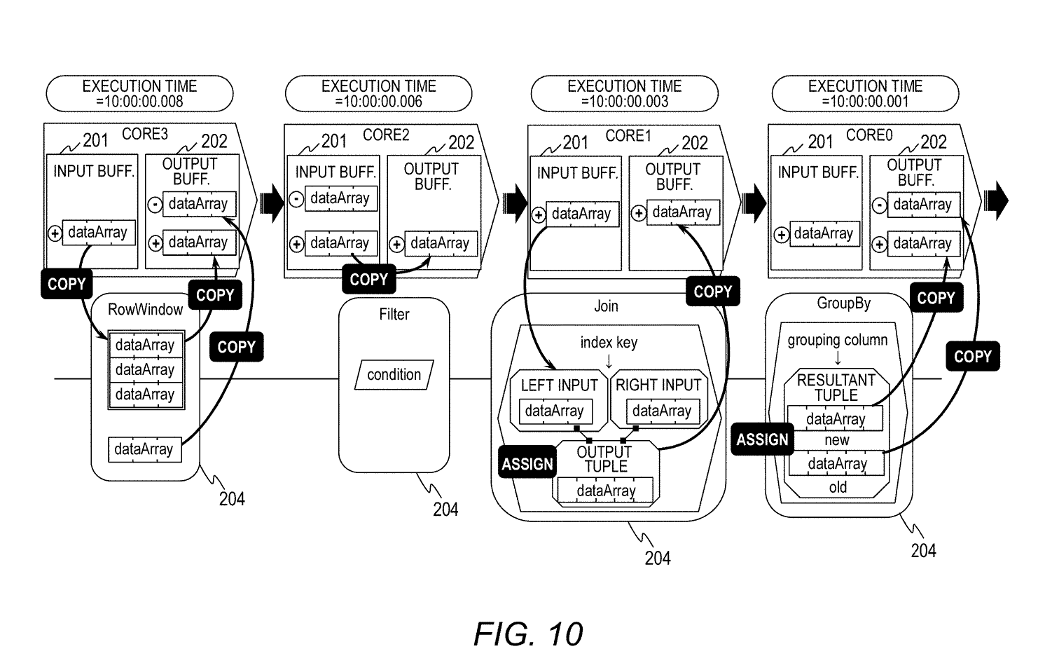

On the other hand, when a check box 801 is selected, the tuples are managed by the copy process shown in FIG. 10. In this copy process, every time the operator process is completed in the query execution thread 200 executed as shown in the respective figures, the input tuple in the tuple input buffer 201 is copied into the operator execution state holding area 204, or the resultant tuple in the operator execution state holding area 204 is copied into the tuple output buffer 202. Alternatively, in this process, a copy of tuples is made between the tuple input buffer 201 and the output buffer 202.

In the bulk update execution thread in the screen 800, one of the two process methods is selected for the reference counter bulk updating process. When a check box 803 is selected, a stage for conducting the reference counter bulk updating process is provided after the last operator process as shown in FIG. 5A, and the updating process of the reference counter 300 is conducted by the query execution thread 200.

On the other hand, when a check box 804 is selected, as shown in FIG. 12, the bulk updating process of the reference counter 300 is conducted by activating the bulk updating threads U0 to U4 by core 4.

The bulk updating process division number in the screen 800 has a pull-down menu 805 that allows the user to select the number of cores to which the bulk updating threads are assigned.

FIG. 10 is a block diagram showing an example of conducting the stream data processing by the copy process described above. Core 0 in the figure shows an example in which the operator of Group By is executed, and the resultant tuple in the operator execution state holding area 204 is copied into the tuple output buffer 202. Core 1 in the figure shows an example in which the operator of Join is executed, the input tuple 121 in the tuple input buffer 201 is copied into the operator execution state holding area 204, and the resultant tuple in the operator execution state holding area 204 is copied into the tuple output buffer 202.

Core 2 in the figure shows an example in which the operator of Filter is executed, and the input tuple in the tuple input buffer 201 is copied in the tuple output buffer 202. Core 3 in the figure shows an example in which the operator of Row Window is executed, the input tuple in the tuple input buffer 201 is copied into the operator execution state holding area 204, and the resultant tuple in the operator execution state holding area 204 is copied into the tuple output buffer 202.

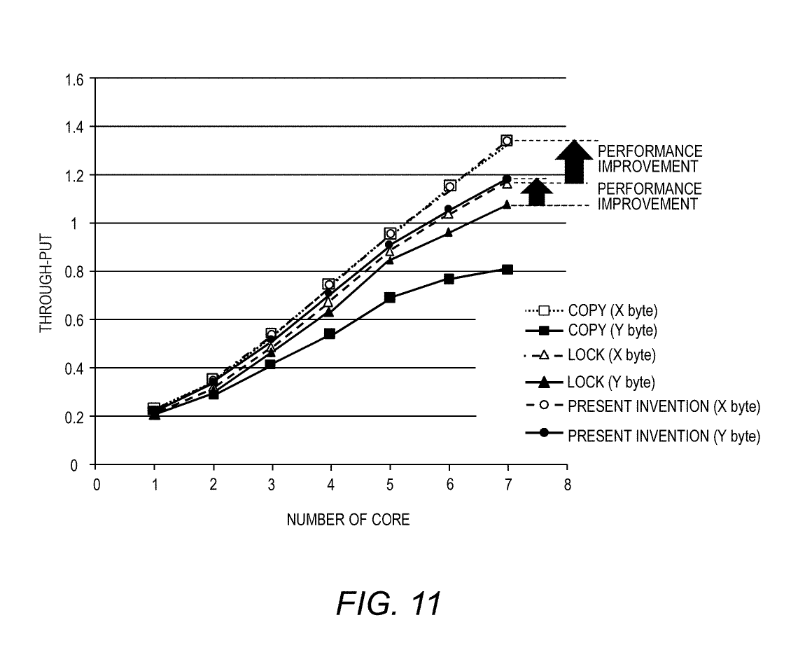

FIG. 11 is a graph showing the relationship between the through-put of the stream data processing and the number of CPU cores 9. The present invention, which is configured to manage the memory for storing tuples through the reference counter bulk updating process, can achieve higher performance than the conventional configuration in which the counter is locked in both cases where the data amount of tuples is small (X bytes) and large (Y Kbyte). In the figure, X byte is approximately from several bytes to 10 bytes, and Y Kbyte is approximately several Kbytes. The vertical axis represents the relative value of the through-put, which can be indicated as several M tuples/sec, for example.

The copy process shown in FIG. 10 results in higher performance than the conventional configuration only when the data amount of tuple is small. This is why the example of selecting the copy process was described as an option in the query execution configuring screen of FIG. 8 above.

### <Conclusion >

As described above, in the present invention, the stream data processing server 100 generates a query graph based on the received stream query 132, and calculates the calculation costs of the respective operators from the query graph. The stream data processing server 100 then divides the query graph into a plurality of stages each including at least one operator such that the sum of the calculation cost of each stage does not exceed a prescribed threshold. The query execution control information 409, which is the query graph divided into a plurality of stages, is generated in this way.

The stream data processing server 100 generates a plurality of query execution threads 200 for successively executing the query execution control information 409 made up of a plurality of stages, and assigns the threads to a plurality of CPU cores 9. The query execution thread 200 does not start the process of a stage (or operator) until the preceding query execution thread 200 completes the process of that stage (or operator).

When the query execution thread 200 completes each operator process, the query execution thread 200 updates the value of the saved tuple number increase and decrease list 203. The values of the saved tuple number increase and decrease list 203 is an increase and decrease number of tuples that are input to and output from the operator execution state holding area 204 and the tuple input buffer 201 or tuple output buffer 202. The increase and decrease values are stored in the saved tuple number increase and decrease list 203 in association with the pointers of those tuples.

When the process of the final stage (or operator) is completed, the query execution thread 200 conducts the bulk updating process of the reference counters 300, thereby identifying the tuples that are no longer necessary based on the sum of the saved tuple number increase and decrease list 203. Thereafter, the storage area of those tuples is recovered and reused.

Thus, at any point in time, the process of one stage (or operator) is conducted by one CPU core 9 (=query execution thread 200) only, and the reference counter bulk updating process is not conducted by the plurality of CPU cores 9 at the same time. As a result, with the present invention, the need for the exclusion control of the reference counter 300 is eliminated, and the process performance of the stream data can be improved.

The bulk updating process of the reference counters 300 may be conducted by adding the reference counter bulk updating process after the last operator in the query process for one tuple as shown in FIG. 5A. Alternatively, the reference counter bulk updating process may be conducted by using independent threads after the final stage (or operator) in the query process for one tuple as shown in FIG. 12.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

What is claimed is:

1. A stream data processing method in which a received tuple is processed with a query using a computer that includes a processor and a memory, the method comprising:
a first step in which the computer generates query execution control information by receiving query definition, converting the query definition into a query graph, and determining an execution order of operators included in the query graph;
a second step in which the computer generates a calculation thread that includes an input buffer configured to store the tuple, an output buffer configured to store a resultant tuple as a process result of the operator, and saved number increase and decrease information configured to store an increase and decrease number of the tuple, and the computer assigns the calculation thread to the processor;
a third step in which the computer configures a temporary storage area in the memory, the temporary storage area being able to store therein the tuple for each of the operators temporarily;
a fourth step in which the computer executes the calculation thread using the query execution control information after receiving the tuple, and the calculation thread stores, in the saved number increase and decrease information, an increase or decrease number of the tuple that was input into and output from the temporary storage area and the input buffer or the output buffer for each tuple when a process of each of the operators is completed;
a fifth step in which the computer calculates a sum of the saved number increase and decrease information for each tuple after the calculation thread completes the process of the last operator in the query graph, and conducts a reference number bulk updating process to identify a tuple that is no longer necessary based on the sum and a prescribed threshold; and
a sixth step in which the computer recovers an area of the identified tuple.

2. The stream data processing method according to claim 1,
wherein, in the first step, the reference number bulk updating process is added after the last operator among the operators included in the query graph of the query execution control information, and
wherein, in the fifth step, the reference number bulk updating process is conducted after the calculation thread completes the process of the last operator in the query graph.

3. The stream data processing method according to claim 1,
wherein the second step includes generating an independent updating thread configured to conduct the reference number bulk updating process, and assigning the thread to a processor, and
wherein, in the fifth step, the updating thread is executed after the calculation thread completes the process of the last operator in the query graph.

4. The stream data processing method according to claim 1,
wherein the processor includes a plurality of processors,
wherein, in the second step, a first calculation thread and a second calculation thread are generated as the calculation thread and assigned to the processors, respectively, and
wherein, in the fourth step, when the second calculation thread conducts a process of the same operator as the first calculation thread, the second calculation thread waits until the first calculation thread completes the process of the same operator, and after the process is completed, the second calculation thread starts the process of the same operator.

5. A stream data processing device that comprises: a processor; and a memory, the stream data processing device being configured to process a received tuple with a query,
wherein the processor generates query execution control information by receiving query definition, converting the query definition into a query graph, and determining an execution order of operators included in the query graph, generates a calculation thread that includes an input buffer configured to store the tuple, an output buffer configured to store a resultant tuple as a process result of the operator, and saved number increase and decrease information configured to store an increase or decrease number of the tuple, and configures a temporary storage area in the memory, the temporary storage area being able to store the tuple for each of the operators temporarily,
wherein the processor executes the calculation thread using the query execution control information after receiving the tuple, and stores, in the saved number increase and decrease information, an increase or decrease number of the tuple that was input to and output from the temporary storage area and the input buffer or the output buffer for each tuple when a process of each of the operators is completed,
wherein the processor calculates a sum of the saved number increase and decrease information for each tuple after the calculation thread completes the process of the last operator in the query graph, and conducts a reference number bulk updating process to identify an unnecessary tuple based on the sum and a prescribed threshold, and
wherein the processor recovers an area of the identified tuple.

6. The stream data processing device according to claim 5,
wherein the processor adds the reference number bulk updating process after the last operator among the operators included in the query graph of the query execution control information, and
wherein the processor conducts the reference number bulk updating process after the calculation thread completes the process of the last operator in the query graph.

7. The stream data processing device according to claim 5,
wherein the processor generates an independent updating thread configured to conduct the reference number bulk updating process, and
wherein the processor executes the updating thread after the calculation thread completes a process of the last operator in the query graph.

8. The stream data processing device according to claim 5,
wherein the processor includes a plurality of processors,
wherein the plurality of processors generate a first calculation thread and a second calculation thread as the calculation thread, and execute the respective threads, and
wherein, in the second calculation thread, before a process of the same operator as the first calculation thread is conducted, the processor waits until the first calculation thread completes the process of the same operator, and after the process is completed, the processor starts the process of the same operator with the second calculation thread.

9. A computer-readable non-transitory data storage medium configured to store a program for processing a received tuple with a query in a computer that includes a processor and a memory, the storage medium that has stored therein a program for causing the computer to execute:
a first process to generate query execution control information by receiving query definition, converting the query definition into a query graph, and determining an execution order of operators included in the query graph;
a second process to generate a calculation thread that includes an input buffer configured to store a tuple, an output buffer configured to store a resultant tuple as a process result of the operator, and saved number increase and decrease information configured to store an increase or decrease number of the tuple, and assign the calculation thread to the processor;
a third process to configure a temporary storage area in the memory, the temporary storage area being able to store the tuple for each of the operators temporarily;
a fourth process to execute the calculation thread using the query execution control information after receiving the tuple, and store, by the calculation thread, an increase or decrease number of the tuple that was input to and output from the temporary storage area and the input buffer or the output buffer for each tuple in the saved number increase and decrease information when a process of each of the operators is completed;
a fifth process to calculate a sum of the saved number increase and decrease information for each tuple after the calculation thread completes the process of the last operator in the query graph, and conduct a reference number bulk updating process to identify an unnecessary tuple based on the sum and a prescribed threshold; and
a sixth process to recover an area of the identified tuple.
